(19) United States
(12) Patent Application Publication
(10) Pub. No.: US 2021/0253942 A1
(43) Pub. Date: Aug. 19, 2021

(54) CHEMICAL ADDITIVES AND SURFACTANT COMBINATIONS FOR FAVORABLE ALTERATION OF HYDROCARBON PROPERTIES AND IMPROVED HYDROCARBON RECOVERY FACTORS

(71) Applicant: Alchemy Sciences, Inc., Houston, TX (US)

(72) Inventors: James P. Russum, Sugar Land, TX (US); Erick Acosta, Sugar Land, TX (US); Shashidhar Rajagopalan, Fulshear, TX (US)

(21) Appl. No.: 17/174,446

(22) Filed: Feb. 12, 2021

Related U.S. Application Data
(60) Provisional application No. 62/977,513, filed on Feb. 17, 2020.

(51) Int. Cl. C09K 8/60; C09K 8/68; C09K 8/74; C09K 8/035; C09K 8/584; E21B 43/26; E21B 43/16

(52) U.S. Cl. CPC C09K 8/602; C09K 8/68; C09K 8/74; E21B 43/16; C09K 8/584; E21B 43/26; C09K 8/035

(57) ABSTRACT

A modified treatment fluid includes a first surfactant, wherein the first surfactant is nonionic, cationic, anionic, zwitterionic, or a combination thereof and a hydrocarbon altering additive (HA), that includes an organic salt, an inorganic salt, urea, a urea derivative, a carbamate, ammonia, an amine, a glycol, a glycol ether, an amide, an aldehyde, or a combination thereof. The modified treatment fluid further includes a treatment fluid.

### CROSS-REFERENCE TO RELATED APPLICATIONS

This application is a non-provisional application which claims priority from U.S. provisional application No. 62/977,513, filed Feb. 17, 2020, which is incorporated by reference herein in its entirety.

### BACKGROUND

### Field

The disclosure relates generally to the field of treatment fluids used in fracturing subterranean formations during hydrocarbon recovery. More specifically the disclosure relates to methods for the physio-chemical properties of the hydrocarbon fluids with chemical additives in the treatment fluids.

### Background Art

Surfactants are in wide use as enhanced recovery and flowback aids in hydrocarbon stimulation operations. These stimulation operations can include primary, secondary or tertiary recovery techniques, as well as hydraulic fracturing. Hydrocarbon recovery via the use of injected chemicals is a multivariate and complex function of several factors, among them are interfacial tension (IFT) reduction, wettability alteration, emulsion tendency, and compatibility with other fluid additives (e.g. friction reducers). Because of this complexity, it is demanding for a single surfactant or mixture of surfactants to address all the governing mechanisms effectively enough to dramatically improve recovery rates. The inherent trade-offs can result in sub-optimal performance in terms of recovery uplift.

Treatment fluids include a number of components and are most often water-based. These components typically include acids, biocides, breakers, corrosion inhibitors, friction reducers, gels, iron control chemicals, oxygen scavengers, surfactants and scale inhibitors. The treatment fluid in combination with the hydrocarbon may flow from the matrix to the fracture network. The treatment fluid and hydrocarbons may then flow from the fracture network to the wellbore.

### SUMMARY

A modified treatment fluid is disclosed. The modified treatment fluid includes a first surfactant, wherein the first surfactant is nonionic, cationic, anionic, zwitterionic, or a combination thereof and a hydrocarbon altering additive (HA) that is an organic salt, an inorganic salt, urea, a urea derivative, a carbamate, or a combination thereof. The modified treatment fluid further includes a treatment fluid.

A method of forming a modified treatment fluid is disclosed. The method includes combining a first surfactant, wherein the first surfactant is nonionic, cationic, anionic, zwitterionic, or a combination thereof with a hydrocarbon altering additive (HA), wherein the HA is an additive or additives that lower the viscosity of the liquid hydrocarbon, lower the density of, or swelling, the liquid hydrocarbon, or chemically convert heavier, more polar, and less mobile components of the hydrocarbons, for example, paraffins, asphaltenes, and bitumens, to lighter, less polar, and more mobile components, and a treatment fluid.

A method of recovering oil from a formation is disclosed. The method includes forming a modified treatment fluid, wherein the modified treatment fluid comprises a hydrocarbon altering additive (HA), a first surfactant, and a treatment fluid. The method also includes introducing the modified treatment fluid into at least a portion of a subterranean reservoir.

### DETAILED DESCRIPTION

The following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

This disclosure is not limited to the embodiments, versions, or examples described, which are included to enable a person having ordinary skill in the art to make and use the disclosed subject matter when the information contained herein is combined with existing information and technology.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations. For example, if the detailed description recites a range of from 1 to 5, that range includes all iterative ranges within that range including, for instance, 1.3-2.7 or 4.9-4.95.

While surfactants may favorably alter the formation wettability and interfacial tension between fluid phases, other chemical species may also be effective at altering the nature of the crude oil. By combining these chemical species with surfactants, oil recovery may be improved compared to individual surfactants or chemical species.

As used herein, the term “hydrocarbon stimulation techniques” means methods of improving the flow of hydrocarbons out of subterranean formations. Certain hydrocarbon stimulation techniques may be commonly referred to as well interventions. In some embodiments, hydrocarbon stimulation techniques include, but are not limited to, hydraulic fracturing treatments, enhanced oil recovery treatments (including, for instance, water flooding treatments and polymer flooding treatments), acidizing treatments, and drilling.

The present disclosure is directed to a mixture of at least one surfactant and one hydrocarbon altering additive (HA) that is combined with treatment fluid to form a modified treatment fluid and injected into a subterranean formation. Other additives suitable for use in the particular application may be included in the treatment fluids as well. These mixtures may be used to treat subterranean formations to improve production of hydrocarbon fluids, for example and without limitation, crude oil and condensate.

As used herein, the term “HA” refers to an additive or additives that may be included in treatment fluids to, for example and without limitation, lower the viscosity of the liquid hydrocarbon, lower the density of, or swelling, the liquid hydrocarbon, and chemically convert heavier, more polar, and less mobile components of the hydrocarbon, for example and without limitation, paraffins, asphaltenes, and bitumens, to lighter, less polar, and more mobile components.

Without being bound by theory, compounds or mixtures of compounds that decompose at reservoir conditions to form gases, e.g. nitrogen, nitrous oxide, carbon dioxide, or carbon monoxide, where such reservoir conditions are favorable to the dissolved gas partitioning to the oil phase, will lower the density of the crude oil, such as by swelling and increase the mobility of the crude oil. Further, compounds or mixtures of compounds that react with the long and heavy carbon chains in crude oil, may convert the heavy carbon chains to shorter, lighter chain lengths and may lower the viscosity of the crude oil and increase the mobility of the crude oil.

The methods, compositions, and systems of the present disclosure may facilitate the evaluation and/or selection of additives for use in improving recovery factors from subterranean hydrocarbon formations. In certain embodiments, these methods may be used in unconventional reservoirs such as shale and/or tight gas formations, where stimulation and enhanced oil recovery operations are used to produce oil and gas. By focusing on additives that have the highest impact on hydrocarbon properties, additives may be selected that target hydrocarbon mobility via viscosity reduction, density reduction, or conversion of the compositional makeup of the oil to lighter, less polar, and more mobile components than originally present in the crude oil.

The HA may be an organic and inorganic salt, urea or a urea derivative or a carbamates.

Examples of organic and inorganic salts that may be suitable for use in certain embodiments of the present disclosure include, but are not limited to ammonium carbonate, ammonium bicarbonate, ammonium nitrate, ammonium nitrite, sodium carbonate, sodium bicarbonate, potassium bicarbonate, and combinations thereof. Organic and inorganic salts may be present in the modified treatment fluid from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Examples of carbamates that may be suitable for use in certain embodiments of the present disclosure include, but are not limited to methyl carbamate, ethyl carbamate, butyl carbamate, ammonium carbamate, amine carbamate, alkanolamine carbamate, benzyl carbamate, phenyl carbamate, and combinations thereof. Carbamates may be present in the modified treatment fluid from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Examples of urea derivatives that may be suitable for use in certain embodiments of the present disclosure include, but are not limited to methyl urea, 1-ethyl urea, 1,1-dimethyl urea, 1,3-dimethyl urea, 1,1-diethyl urea, bi(hydroymethyl) urea, and combinations thereof. Urea derivatives may be present in the modified treatment fluid from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %. Urea may be present in the modified treatment fluid in a concentration of from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Surfactants used in the present mixture may include nonionic, cationic, anionic, zwitterionic (also sometimes referred to as amphoteric) surfactants, and combinations thereof. Surfactants may be present in the modified treatment fluid in a concentration of from 0 wt % to approximately 15 wt %, such as in a range of about 0 wt % to about 12 wt %, about 2 wt % to about 10 wt %, or about 5 wt % to about 8 wt %. More particularly, the concentration may be about 0 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, or about 15 wt %.

Examples of nonionic surfactants include, but are not limited to, alcohol oxylalkylates, alkyl phenol oxylalkylates, nonionic esters such as sorbitan esters alkoxylates of sorbitan esters, castor oil alkoxylates, fatty acid alkoxylates, lauryl alcohol alkoxylates, nonylphenol alkoxylates, octylphenol alkoxylates, and tridecyl alcohol alkoxylate, derivatives thereof, and combinations thereof.

Examples of cationic surfactants include, but are not limited to, alkyl amines, alkyl amine salts, quaternary ammonium salts such as trimethyltallowammonium halides (e.g., trimethyltallowammonium chloride, trimethyltallowammonium bromide), amine oxides, alkyltrimethyl amines, triethyl amines, alkyldimethylbenzylamines, cetyltrimethylammonium bromide, alkyl dimethyl benzyl-ammonium chloride, trimethylcocoammonium chloride, derivatives thereof, and combinations thereof.

Examples of anionic surfactants include, but are not limited to, alkyl carboxylates, alkylether carboxylates, N-acylaminoacids, N-acylglutamates, N-acyl-polypeptides, alkylbenzenesulfonates, paraffinic sulfonates, α-olefinsulfonates, lignosulfates, derivatives of sulfosuccinates, polynapthylmethylsulfonates, alkyl sulfates, alkylethersulfates, C8 to C22 alkylethoxylate sulfate, alkylphenol ethoxylate sulfate (or salts thereof), monoalkylphosphates, polyalkylphosphates, fatty acids, alkali salts of fatty acids, glyceride sulfates, sodium salts of fatty acids, soaps, derivatives thereof, and combinations thereof.

Examples of amphoteric or zwitterionic surfactants include, but are not limited to, dihydroxyl alkyl glycinate, alkyl ampho acetate or propionate, alkyl betaine, alkyl amidopropyl betaine and alkylimino mono- or di-propionates derived from certain waxes, fats and oils, and combinations thereof.

In certain embodiments, the nonionic, cationic, anionic, and/or zwitterionic surfactant(s) selected according to the methods of the present disclosure may be used in combination with one or more additional surfactants, including but not limited to nonionic, cationic, anionic, and/or zwitterionic surfactant(s), and combinations thereof. The inclusion and/or selection of such surfactants may depend upon, additional experiments or tests performed to evaluate one or more properties of the surfactant and/or its interaction with rock surfaces and/or oil in the subterranean formation.

In certain embodiments of the present disclosure, one or more experimental tests may be used to evaluate the functionality of the nonionic, cationic, anionic, and/or zwitterionic surfactants and HA combination. In certain embodiments, those tests may include, but are not limited to, water solubility tests, emulsion tendency tests, interfacial surface tension measurements, wettability via contact angle, spontaneous imbibition tests, hydrocarbon recovery tests, and adsorption tests.

The treating surfactant(s) selected according to the methods of the present disclosure may be incorporated into a treatment fluid that is introduced into at least a portion of a subterranean formation, for example, through a well bore. The treatment fluids used may include a base fluid, including aqueous base fluids, non-aqueous base fluids, and combinations thereof. Aqueous base fluids that may be suitable for use in the methods and systems of the present disclosure may include water, such as fresh water, salt water (e.g., water containing one or more salts dissolved therein), brine (e.g., saturated salt water), seawater, or any combination thereof. The aqueous fluids include one or more ionic species, such as those formed by salts dissolved in water. For example, seawater and/or produced water may comprise a variety of divalent cationic species dissolved therein. In certain embodiments, the density of the aqueous base fluid can be adjusted, for example, to provide additional particulate transport and suspension in the compositions of the present disclosure. In certain embodiments, the pH of the aqueous fluid may be adjusted (e.g., by a buffer or other pH adjusting agent) to a specific level, which may depend on, among other factors, the types of viscosifying agents, acids, and other additives included in the fluid. Non-limiting examples of non-aqueous fluids that may be suitable for use in the methods and systems of the present disclosure include, but are not limited to, oils, hydrocarbons, and organic liquids. In certain embodiments, the treatment fluid may include a mixture of one or more fluids and/or gases, including but not limited to emulsions, foams, and the like.

In certain embodiments, the treatment fluids used in the methods and systems of the present disclosure may include additives. Examples of such additives include, but are not limited to, salts, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, additional H₂S scavengers, CO₂ scavengers, oxygen scavengers, lubricants, additional viscosifiers, breakers, weighting agents, relative permeability modifiers, resins, wetting agents, coating enhancement agents, filter cake removal agents, antifreeze agents (e.g., ethylene glycol), nanoparticles, and combinations thereof.

Processes in which such modified treatment fluids may be used may include, but are not limited to, hydraulic fracturing treatments, enhanced oil recovery treatments (including, for instance, water flooding treatments and polymer flooding treatments), re-fracs, re-pressurization (such as parent-child well scenarios), remediations, recompletions, acidizing treatments, and drilling. In certain embodiments, the low permeability reservoir may be contacted by the modified treatment fluid, such as, for instance, introduction into a well bore that penetrates the low permeability reservoir. The modified treatment fluid may be formed in-situ or ex situ. The mixture may be formed in-situ, partially in-situ, or ex-situ.

1. A modified treatment fluid comprising:
a first surfactant, wherein the first surfactant is nonionic, cationic, anionic, zwitterionic, or a combination thereof;
a hydrocarbon altering additive (HA) comprising an organic salt, an inorganic salt, urea, a urea derivative, a carbamate, or a combination thereof; and
a treatment fluid.

2. The modified treatment fluid of claim 1, wherein the HA is an organic salt or inorganic salt selected from the group consisting of ammonium carbonate, ammonium bicarbonate, ammonium nitrate, ammonium nitrite, sodium carbonate, sodium bicarbonate, potassium bicarbonate, and combinations thereof.

3. The modified treatment fluid of claim 1, wherein the HA is a urea derivative selected from the group consisting of methyl urea, 1-ethyl urea, 1,1-dimethyl urea, 1,3-dimethyl urea, 1,1-diethyl urea, bi(hydroymethyl) urea, urea ammonium nitrate and combinations thereof.

4. The modified treatment fluid of claim 1, wherein the HA is a carbamate selected from the group consisting of methyl carbamate, ethyl carbamate, butyl carbamate, ammonium carbamate, amine carbamate, alkanolamine carbamate, benzyl carbamate, phenyl carbamate, and combinations thereof.

5. The modified treatment fluid of claim 1, further comprising a second surfactant, wherein the second surfactant is different from the first surfactant.

6. The modified treatment fluid of claim 5, wherein the second surfactant is nonionic, cationic, anionic, zwitterionic, or a combination thereof.

7. The modified treatment fluid of claim 1, wherein the first surfactant is nonionic and selected from the group consisting of alcohol oxylalkylates, alkyl phenol oxylalkylates, nonionic esters, castor oil alkoxylates, fatty acid alkoxylates, lauryl alcohol alkoxylates, nonylphenol alkoxylates, octylphenol alkoxylates, and tridecyl alcohol alkoxylate, derivatives thereof, and combinations thereof.

8. The modified treatment fluid of claim 1, wherein the first surfactant is cationic and selected from the group consisting of alkyl amines, alkyl amine salts, quaternary ammonium salts such as trimethyltallowammonium halides, amine oxides, alkyltrimethyl amines, triethyl amines, alkyldimethylbenzylamines, cetyltrimethylammonium bromide, alkyl dimethyl benzyl-ammonium chloride, trimethylcocoammonium chloride, derivatives thereof, and combinations thereof.

9. The modified treatment fluid of claim 1, wherein the first surfactant is anionic and selected from the group consisting of alkyl carboxylates, alkylether carboxylates, N-acylaminoacids, N-acylglutamates, N-acyl-polypeptides, alkylbenzenesulfonates, paraffinic sulfonates, α-olefinsulfonates, lignosulfates, derivatives of sulfosuccinates, polynapthylmethylsulfonates, alkyl sulfates, alkylethersulfates, C8 to C22 alkylethoxylate sulfate, alkylphenol ethoxylate sulfate or salts thereof, monoalkylphosphates, polyalkylphosphates, fatty acids, alkali salts of fatty acids, glyceride sulfates, sodium salts of fatty acids, soaps, derivatives thereof, and combinations thereof.

10. The modified treatment fluid of claim 1, wherein the first surfactant is zwitterionic and selected from the group consisting of dihydroxyl alkyl glycinate, alkyl ampho acetate, alkyl ampho propionate, alkyl betaine, alkyl amidopropyl betaine, alkylimino mono- or di-propionates derived from waxes, fats or oils, and combinations thereof.

11. The modified treatment fluid of claim 1, wherein the treatment fluid is an aqueous fluid, a non-aqueous fluid, or a combination thereof.

12. A method of forming a modified treatment fluid comprising:
combining a first surfactant, wherein the first surfactant is nonionic, cationic, anionic, zwitterionic, or a combination thereof with a hydrocarbon altering additive (HA), wherein the HA is an additive or additives that lower the viscosity of the liquid hydrocarbon, lower the density of, or swelling, the liquid hydrocarbon, or chemically convert paraffins, asphaltenes, and bitumens to lighter, less polar, and more mobile components.

13. The method of claim 12, wherein the modified treatment fluid is formed in-situ or ex-situ.

14. A method of recovering oil from a formation comprising:
forming a modified treatment fluid, wherein the modified treatment fluid comprises a hydrocarbon altering additive (HA), a first surfactant, and a treatment fluid; and
introducing the modified treatment fluid into at least a portion of a subterranean reservoir.

15. The method of claim 14, wherein the modified treatment fluid is formed in-situ or ex-situ.

16. The method of claim 14, wherein the method of recovering oil is performed hydraulic fracturing treatments, water flooding treatments, polymer flooding treatments, acidizing treatments, or drilling.

17. The method of claim 16, wherein the treatment fluid further comprises an additive, the additive selected from the group consisting of salts, acids, proppant particulates, diverting agents, fluid loss control additives, gas, nitrogen, carbon dioxide, surface modifying agents, tackifying agents, foamers, corrosion inhibitors, scale inhibitors, catalysts, clay control agents, biocides, friction reducers, antifoam agents, bridging agents, flocculants, additional H₂S scavengers, CO₂ scavengers, oxygen scavengers, lubricants, additional viscosifiers, breakers, weighting agents, relative permeability modifiers, resins, wetting agents, coating enhancement agents, filter cake removal agents, antifreeze agents, nanoparticles, and combinations thereof.

18. The method of claim 16, wherein the modified treatment fluid is introduced into the subterranean formation through a wellbore.

19. The method of claim 16, wherein the functionality of the mixture of the first surfactant and HA is performed using water solubility tests, emulsion tendency tests, interfacial surface tension measurements, wettability via contact angle, spontaneous imbibition tests, hydrocarbon recovery tests, adsorption tests, or a combination thereof.
